(19) United States
(12) Patent Application Publication
(10) Pub. No.: US 2026/0088696 A1
(43) Pub. Date: Mar. 26, 2026

(54) COIL SYSTEM FOR A SUPERCONDUCTING MOTOR

(71) Applicant: Airbus SAS, BLAGNAC (FR)

(72) Inventors: Alexandre COLLE, BLAGNAC (FR); Reda ABDOUH, BLAGNAC (FR)

(21) Appl. No.: 19/332,222

(22) Filed: Sep. 18, 2025

(30) Foreign Application Priority Data
Sep. 20, 2024 (FR) FR2410073

(51) Int. Cl. H02K 55/02

(52) U.S. Cl. CPC H02K 55/02

(57) ABSTRACT

A superconducting coil system having a coil of superconducting strips, stacked one against the other and wound so as to form rectilinear sections passing through a first orifice and a second orifice and a winding of at least one turn comprising rectilinear sub-sections passing through each of the two orifices and a heat-exchanger system having, for each orifice, a thermal unit arranged in the orifice and positioned against an edge face of each strip arranged in the same orifice, at least one duct embedded in the thermal unit and having a heat-transfer fluid passing through it, and two radiator plates arranged in the respective orifice and arranged one on each side of the thermal unit and of the strips arranged in the same orifice where each radiator plate is fixed against the thermal unit.

### CROSS-REFERENCES TO RELATED APPLICATIONS

This application claims the benefit of French Patent Application Number FR2410073 filed on Sep. 20, 2024, the entire disclosure of which is incorporated herein by way of reference.

### FIELD OF THE INVENTION

The present invention relates to the general field of superconducting motors and relates more particularly to a coil system for a superconducting motor and to a superconducting motor comprising a plurality of such coil systems.

### BACKGROUND OF THE INVENTION

A superconducting motor comprises a rotor with a rotor core made of a ferromagnetic material. The rotor core is cylindrical and it has a central bore into which a drive shaft is fitted and rigidly fixed.

The rotor also comprises permanent magnets fixed to the rotor core on the periphery of the latter. There are several permanent magnets distributed angularly and regularly around the rotor core and spaced apart from one another. Conventionally, the permanent magnets are magnetized radially with respect to a longitudinal axis and alternately from one to the next.

The superconducting motor comprises a stator which is positioned outside the rotor and which comprises a stator core made of a ferromagnetic material. The stator core has a cylindrical overall shape and, on its cylindrical face oriented toward the rotor, it has orifices distributed angularly and regularly around the rotor. The orifices are arranged in pairs and the two orifices of the pair are separated by a tooth which is integral and made of one piece with the stator core.

For each pair of orifices, the stator comprises a coil which is wound around the tooth and which is made of a superconducting material.

In operation, each coil is supplied with electrical power in order to generate a magnetic field which interacts with the permanent magnets in order to drive them in rotation with the rotor and the drive shaft.

Although such an arrangement gives good results, the coils experience significant heating which limits their performance and it is therefore desirable to find an arrangement which improves the situation.

### SUMMARY OF THE INVENTION

An object of the present invention is to propose a coil system which may be installed in a superconducting motor and the heating of which is limited in order to improve performance.

To this end, what is proposed is a coil system for a superconducting motor comprising a first and a second orifice, said coil system comprising:
a coil made up of a plurality of strips made of a superconducting material, of rectangular cross section, stacked one against the other and wound so as to form a first rectilinear section intended to pass through the first orifice and having a first end and a second end, a second rectilinear section intended to pass through the second orifice and having a first end and a second end, and a winding of at least one turn connecting the second ends to one another and comprising rectilinear sub-sections intended to pass through one of the two orifices, and curved sub-sections intended to lie outside the orifices and connecting the rectilinear sections and sub-sections to one another, and
a heat-exchanger system comprising, for each orifice that the coil is intended to pass through:
a thermal unit intended to be arranged in said orifice and positioned against an edge face of each strip arranged in the same orifice,
at least one duct embedded in the thermal unit and intended to have a heat-transfer fluid passing through it, and
two radiator plates intended to be arranged in said orifice and arranged one on each side of the thermal unit and of the strips arranged in the same orifice where each radiator plate is fixed against the thermal unit.

With such an arrangement, the heating of the coil system is limited.

Advantageously, the duct passing through one thermal unit and the duct passing through the other thermal unit of the same heat-exchanger system are fluidically connected by a connecting duct.

Advantageously, each radiator plate is made of ceramic.

Advantageously, the thermal unit is made of cupronickel.

The invention also proposes a superconducting motor comprising:
a rotor with a rotor core bearing permanent magnets and able to rotate about a longitudinal axis,
a stator arranged outside the rotor and comprising a stator core through which there pass a plurality of pairs of a first and of a second orifice distributed angularly and regularly around the rotor, and
for each pair of orifices, a coil system according to one of the preceding variants.

### BRIEF DESCRIPTION OF THE DRAWINGS

The abovementioned features of the invention, along with others, will become more clearly apparent upon reading the following description of one exemplary embodiment, said description being given with reference to the appended drawings, in which:

FIG. 1 is a view in cross section of a superconducting motor according to the invention,

FIG. 2 is a perspective view of a coil system according to the invention, and

FIG. 3 is a view in cross section of a coil system according to the invention.

### DETAILED DESCRIPTION OF THE PREFERRED EMBODIMENTS

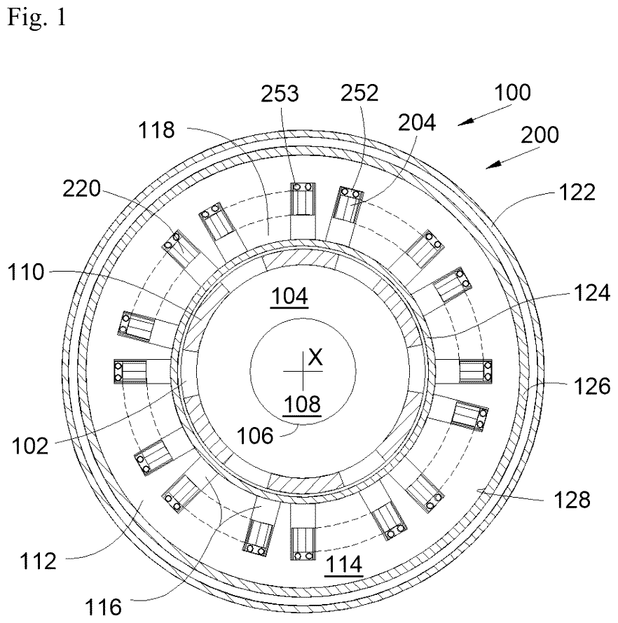

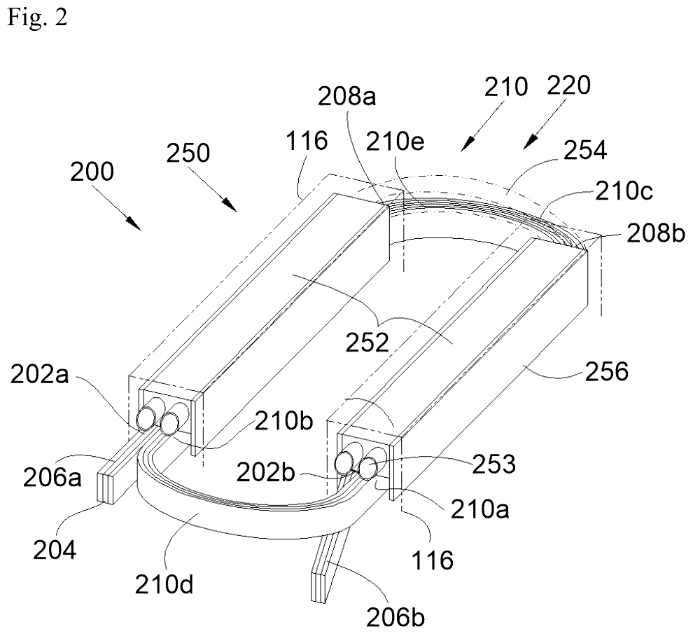

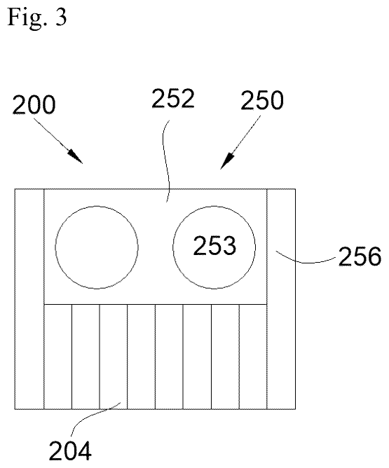

FIG. 1 shows a superconducting motor 100 according to the invention, seen in cross section on a plane perpendicular to a longitudinal axis X of said superconducting motor 100, and FIGS. 2 and 3 show a coil system 200 according to the invention and implemented in the superconducting motor 100.

The superconducting motor 100 comprises a rotor 102 which has a rotor core 104 made of a ferromagnetic material such as the collection of iron alloys used for electric machines. The rotor core 104 is cylindrical and coaxial with the longitudinal axis X and has a central bore 106 into which a motor shaft 108 of said superconducting motor 100 is fitted and rigidly fixed. The drive shaft 108 is coaxial with the longitudinal axis X.

The rotor 102 also comprises permanent magnets 110 which are fixed to the rotor core 104 on the periphery of the latter. There are a plurality of permanent magnets 110 (in this case six) distributed angularly and regularly around the rotor core 104 and spaced apart from one another. Preferably, the permanent magnets 110 are magnetized radially with respect to the longitudinal axis X and alternately from one to the next.

The superconducting motor 100 also comprises a stator 112 which is positioned outside the rotor 102 and which has a stator core 114 made of a ferromagnetic material such as the collection of iron alloys used for electric machines. The stator core 114 has a generally cylindrical shape coaxial with the longitudinal axis X.

At its cylindrical face which is oriented toward the rotor 102, the stator core 114 has orifices 116, in this case in the form of slots which open out facing the rotor 102. According to one embodiment which is not shown, the orifices 116 may be in the form of tunnels passing through the stator core 114.

The orifices 116 extend parallel to the longitudinal axis X.

There are a plurality of orifices 116 (in this case sixteen) which are distributed angularly and regularly around the rotor 102 and which are arranged in pairs.

The two orifices 116 of the pair are separated by a tooth 118 which is integral and made of one piece with the stator core 114. In the case of orifices 116 in the form of a tunnel, the orifices 116 are embedded in the stator core 114.

For each pair of orifices 116, the stator 112 comprises a coil system 200 installed in the pair of orifices 116 of the stator core 114.

The coil system 200 comprises a coil 220 made up of several strips 204 of rectangular cross section, in this case three, which are placed back-to-back via their large surfaces, against one another so as to form a stack, and wound on themselves to form turns which are generally flat. Each strip 204 consists of a superconducting material, and two successive strips 204 in the stack are electrically insulated one from the other by a layer of an electrically insulating material, such as a coat of a polyimide varnish, arranged between them, which is to say that an electrically insulating material is placed between the contacting large surfaces of the two successive strips 204.

The coil 220 comprises a first rectilinear section 202a which passes through a first orifice 116 of the pair of orifices 116, and a second rectilinear section 202b which passes through a second orifice 116 of the pair of orifices 116. Each section thus consists of a stack of strips 204.

The first section 202a and the second section 202b each have a first end 206a-b which is electrically connected to an electrical power source and a second end 208a-b. All of the strips 204 are electrically connected to the electrical power source at each first end 206a-b, which means to say that the current flows through all of the strips 204 of the coil 220. The strips 204 are thus electrically insulated from one another along the path between the first ends 206a-b but are electrically connected at the first ends 206a-b.

The coil 220 also comprises a winding 210 at least one turn which connects the second ends 208a-b to one another. The winding 210 comprises rectilinear sub-sections which pass through one of the two orifices 116, and curved sub-sections which lie outside the orifices 116 and connect the rectilinear sections and sub-sections to one another.

In the embodiment of the invention that is shown in FIG. 2, the winding 210 has a single turn and comprises a rectilinear first sub-section 210a which passes through the second orifice 116, a rectilinear second sub-section 210b which passes through the first orifice 116, a curved third sub-section 210c which connects the second end 208a of the first section 202a to the first sub-section 210a, a curved fourth sub-section 210d which connects the first sub-section 210a to the second sub-section 210b and a fifth sub-section 210e which connects the second sub-section 210b to the second end 208b of the second section 202b.

Of course, the arrangement may be different depending on the number of turns of the winding 210.

The strips 204 of each section 202a-b and of each rectilinear sub-section 210a-b which pass through an orifice 116 are positioned next to one another back-to-back via their large surfaces.

The coil system 200 also comprises a heat-exchanger system 250.

For each orifice 116 through which the coil 220 passes, the heat-exchanger system 250 comprises a thermal unit 252 made up of a thermally conductive material having, in particular, a thermal conductivity greater than 10 W/m/K. The thermal unit 252 is for example made of cupronickel.

The thermal unit 252 is positioned against an edge face of each strip 204 which is in the same orifice 116 as it, which is to say against the edge face of each strip 204 of the section 202a-b and of each rectilinear sub-section 210a-b which pass through the same orifice 116. The heat of the strips 204 is thus transmitted to the thermal unit 252.

Each thermal unit 252 is thus arranged in an orifice 116 and also has passing through it at least one duct 253 (in this case two) of the heat exchanger-system 250. Each duct 253 is therefore embedded in the associated thermal unit 252 and extends along the orifice 116 parallel to the longitudinal axis X.

Each duct 253 has, passing through it, a heat-transfer fluid coming from a reservoir of heat-transfer fluid and driven by any appropriate system such as a pump. The heat-transfer fluid is, for example, helium gas. The heat-transfer fluid is colder than the thermal unit 252 in order to remove heat energy.

In the embodiment of the invention presented here, each duct 253 passing through one orifice 116 is fluidically connected to a duct 253 passing through the other orifice 116 of the pair of orifices 116, by a connecting duct 254 which is in this case in the form of an arc of a circle and which lies against the curved third sub-section 210c and fifth sub-section 210e. The connecting ducts 254 are represented here by double-dot chain lines.

The heat-exchanger system 250 also comprises, for each thermal unit 252, two radiator plates 256 which are arranged in the orifice 116 corresponding to said thermal unit 252. The radiator plates 256 are arranged one on each side of the thermal unit 252 and of the strips 204 of the section 202a-b and of each rectilinear sub-section 210a-b which pass through the same orifice 116. Each radiator plate 256 thus extends heightwise over the height of the strips 204, corresponding to their large surfaces, and over the height of the thermal unit 252.

Each radiator plate 256 is furthermore fixed against the thermal unit 252 for example by soldering. Each radiator plate 256 consists of a thermally conductive material having, in particular, a thermal conductivity higher than 100 W/m/K. Each radiator plate 256 is for example made of ceramic, such as aluminum oxide (Al₂O₃).

Each radiator plate 256 may also be covered with a layer of metal such as copper which facilitates connection, by soldering, to the thermal unit 252 when this too is made of metal such as cupronickel.

With such an arrangement, the heat of the strips 204 is removed better than in the case of the prior art.

The rotor 102 and the stator 112 are housed here in a motor housing 122 closed at its two ends by endplates, at least one of which is pierced with a central orifice allowing the passage of the drive shaft 108. The stator 112 is mounted fixedly inside the motor housing 122 while the rotor 102 and the drive shaft 108 are mounted with the freedom to rotate inside the motor housing 122, for example through the use of bearings.

In operation, each coil 220 is supplied with electrical power in order to generate a magnetic field which interacts with the permanent magnets 110 in order to drive them in rotation with the rotor 102 and the drive shaft 108.

Here, the superconducting motor 100 comprises an inner cylinder 124 and an outer cylinder 126 which are coaxial with the longitudinal axis X.

The inner cylinder 124 is arranged between the rotor 102 and the stator 112, and the outer cylinder 126 is arranged around the stator 112 and inside the motor housing 122.

The inner cylinder 124 and the outer cylinder 126 extend between the two endplates to which they are hermetically fixed in order to delimit, between themselves and the two endplates, a chamber 128 in which the stator 112 is housed and which can be placed under vacuum.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority. Claimed is:

1. A coil system for a superconducting motor having a first orifice and a second orifice, the coil system comprising:
a coil formed by a plurality of strips made of a superconducting material, having a rectangular cross section, and stacked one against the other and wound so as to form a first rectilinear section configured to pass through the first orifice and having a first end and a second end, a second rectilinear section configured to pass through the second orifice and having a first end and a second end, and a winding of at least one turn connecting the second ends to one another and comprising rectilinear sub-sections configured to pass through one of the first and second orifices, and curved sub-sections intended to lie outside the first orifice and the second orifice and connecting the first and the second rectilinear sections and the rectilinear sub-sections to one another; and
a heat-exchanger system comprising, for each orifice that the coil is configured to pass through:
a thermal unit configured to be arranged in said orifice and positioned against an edge face of each strip arranged in said orifice;
at least one duct embedded in the thermal unit and configured to have a heat-transfer fluid passing there through; and
two radiator plates configured to be arranged in said orifice and arranged one on each side of the thermal unit and of the strips arranged in said orifice where each radiator plate is fixed against the thermal unit.

2. The coil system according to claim 1, wherein the at least one duct passing the thermal unit of the first orifice and the at least one duct passing through the thermal unit of the second orifice are fluidically connected by a connecting duct.

3. The coil system according to claim 1, wherein each radiator plate is made of ceramic.

4. The coil system according to claim 1, wherein each thermal unit is made of cupronickel.

5. A superconducting motor comprising:
a rotor with a rotor core bearing permanent magnets and configured to rotate about a longitudinal axis;
a stator arranged outside the rotor and comprising a stator core through which there pass a plurality of pairs of a first orifice and a second orifice distributed angularly and regularly around the rotor, and
for each pair of orifices, the coil system according to claim 1.
